(19) United States
(12) Patent Application Publication
(10) Pub. No.: US 2011/0305502 A1
(43) Pub. Date: Dec. 15, 2011

(54) POSITIONING SWITCH MECHANISM FOR FOLDABLE ASSEMBLY OF BICYCLES

(76) Inventor: Chiu-Hsiang Lo, Taichung (TW)

(21) Appl. No.: 12/797,628

(22) Filed: Jun. 10, 2010

(51) Int. Cl. F16B 21/12

(52) U.S. Cl. 403/84

(57) ABSTRACT

The present invention relates to a positioning switch mechanism for foldable assembly of bicycles, comprising a positioning switch assembly, a first rotary member and a second rotary member which are able to revolve against each other along a rotation axis. The positioning switch assembly has a press button assembly set in the first rotary member with a spring and a pin set in the second rotary member with a spring as well. When the first rotary member revolves close to overlap against the second rotary member, the first rotary member pushes the pin to be drowned back into the second rotary member. The first rotary member continues to revolve against the second rotary member till they are completely overlapped. The pin limits itself in the first rotary member so as to fix with the second rotary member. When the press button assembly takes pressure from the user, it pushes the limit portion to be drowned back into the second rotary member so that the positioning switch assembly is in an unlocked state and the first rotary member is capable of revolving against the second rotary member.

### FIELD OF THE INVENTION

The present invention relates to a positioning switch mechanism for foldable assembly of bicycles, particularly to a device which is applied to two rotatable members of bicycles. When a bicycle is unfolded, it allows entire frame to be automatically extended in position. On the other hand, when the bicycle is intended to be folded, it can be done by certain simple manipulation demonstrated in the invented technique.

### BACKGROUND OF THE INVENTION

According to the prior art of a bicycle, its basic structure comprises of a front frame, a rear frame, a front wheel installed on the front frame and a rear wheel on the rear frame. Due to the fixed length of a regular bicycle, it is inconvenient for the bicycle to be transported or carried from a place to another. Particularly, riding a bicycle is considered as a recreational activity for a lot of people nowadays, and they usually enjoy riding their own bicycle everywhere. Even when they go to a place where is far away from home, they still want to ride their own bicycle. Consequently, there have been many people trying to carry their own bicycle with them while traveling. When they stop at a place, they can ride their bike to visit around. That gives a reason why folding bikes are invented. The foldable function allows their owners to expediently load them into cars and conveniently carry them to places where they have fun riding.

In the prior arts, there are many kinds of folding bikes with different design of folding mechanism and, in general, there must be a fastening device for a bike to be fully extended in order to provide a normal and secure riding state for a bike rider. The prior art of a fastening device normally seen is equipped with a quick release device which costs higher and is limited by specific structure for installation. There are also prior arts of fastening devices simply apply hinges to secure bikes, and they always require manual operation no matter in the state of locked or unlocked. In addition, the exposure of hinges not only affects the artistic appearance of bikes but also is easier for the hinges to be accidentally reached and actuated causing safety problems.

Somehow, the prior arts have certain disadvantages and should be improved. The inventor of the present invention, with many years' experience of development of recreational devices, devotes himself to experiment and improve prior designs. The present invention is made a better product to achieve the following objectives.

### SUMMARY OF THE INVENTION

The object of the present invention is to provide a positioning switch mechanism with simplified structure, optimized security, easier manipulation and low cost for foldable assembly of bicycles.

In order to achieve the foregoing object, the present invention is designed to comprise a positioning switch assembly, a first rotary member and a second rotary member being able to revolve against each other along a rotation axis. The positioning switch assembly has a press button assembly set in the first rotary member with a spring and a pin set in the second rotary member with a spring as well. When the first rotary member revolves close to overlap against the second rotary member, the first rotary member pushes a limit portion of the pin for the limit portion to be drowned back into the second rotary member. The first rotary member continues to revolve against the second rotary member till they are completely overlapped. In the mean time, the limit portion takes pressure from the spring to limit itself in the first rotary member and, therefore, the first rotary member is relatively fixed on the second rotary member. When the press button assembly takes pressure from the user, it pushes the limit portion to be drowned back into the second rotary member so that the positioning switch assembly is in an unlocked state and the first rotary member is capable of revolving against the second rotary member.

### BRIEF DESCRIPTION OF THE DRAWINGS

FIG. 1 is an exploded schematic drawing of the present invention;

FIG. 2 is an assembled perspective drawing of the present invention;

FIG. 3 is a top view of assembled schematic drawing in accordance with the present invention;

FIG. 4 is a cross sectional view taken along the line A-A in FIG. 3 of the present invention;

FIG. 5 is an exploded schematic drawing of a positioning switch assembly in accordance with the present invention;

FIG. 6 is an entire perspective drawing of an unfolded bicycle in accordance with the present invention;

FIG. 7 is an entire side view of an unfolded bicycle in accordance with the present invention;

FIG. 8 is an entire top view of an unfolded bicycle in accordance with the present invention;

FIG. 9 is an entire perspective drawing of a folded bicycle in accordance with the present invention; and

FIG. 10 is a schematic drawing of a first rotary member and a second rotary member extended away from a rotation axis in accordance with the present invention.

### DETAILED DESCRIPTION OF THE PREFERRED EMBODIMENT

### I. Basic Structure of the Present Invention

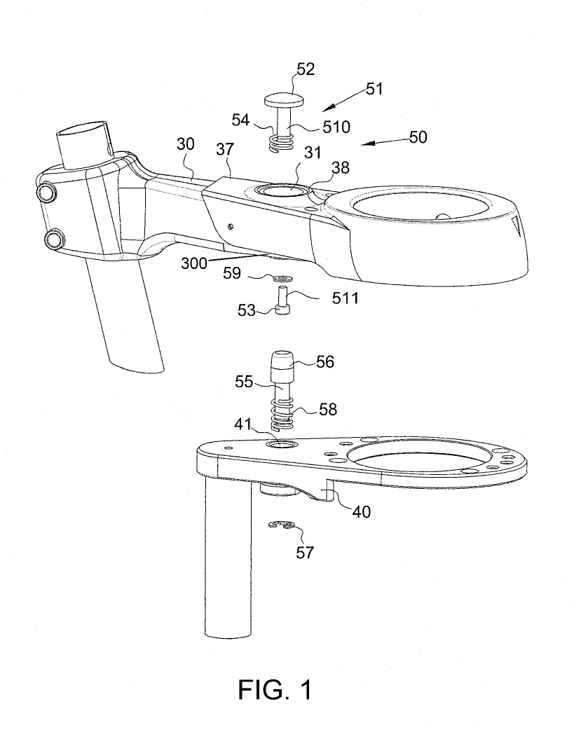

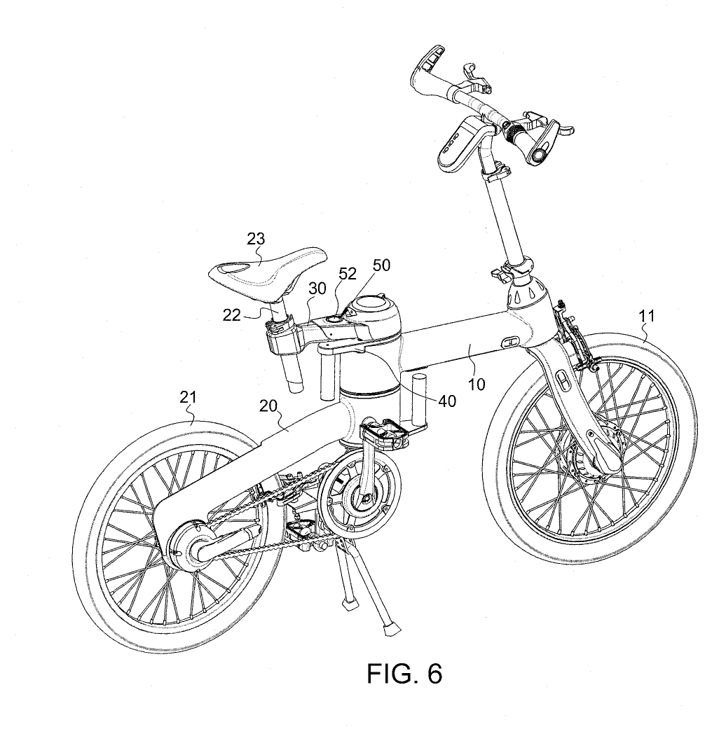

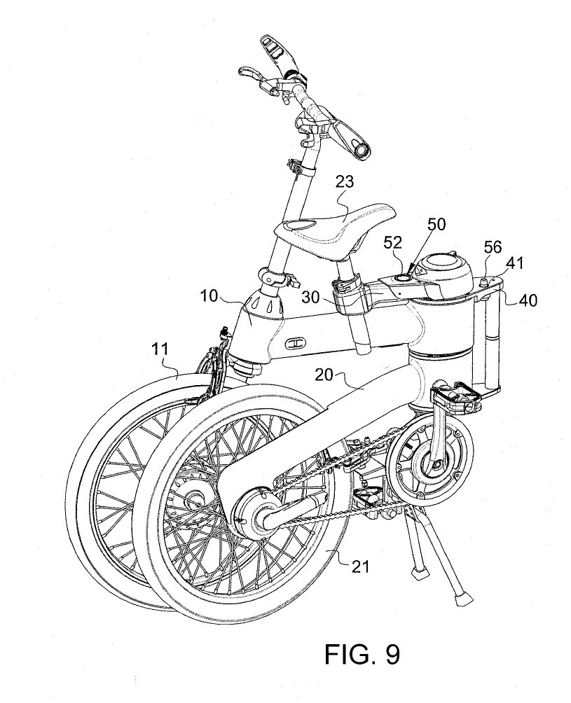

Referring to FIG. 1 to FIG. 4, the present invention is designed to improve a positioning switch mechanism for foldable assembly of bicycles. The basic structure of a regular bicycle, shown as FIG. 6, comprises of a front frame 10, a rear frame 20, a front wheel 11 installed on a front frame 10 and a rear wheel 21 on a rear frame 20. Though there are many kinds of the folding mechanism for bicycles, their basic structures are the same. A folding bike usually comprises a first rotary member 30, a second rotary member 40, a rotation axis 60 and a positioning switch assembly 50. When the positioning switch assembly 50 is actuated by a user to the unlocked state, the first rotary member 30 is able to be freely revolved against the second rotary member 40 along the rotation axis 60 and the user can easily revolve the first rotary member 30 against the second rotary member 40. Therefore, the front frame 10 can be folded relative to the rear frame 20, shown as FIG. 9, and it allows the folding bike to be transported with convenience. When the positioning switch assembly 50 is actuated to the locked state, the first rotary member 30 is fixed against the second rotary member 40 and the folding bike, shown as FIG. 6, can be fully extended for normal riding.

### II. Features of the Present Invention

### i. Features of the First Rotary Member

Referring to FIG. 1 to FIG. 4, the first rotary member 30 of the present invention has a first punch 31, which has a first end and a second end in opposite direction, vertically penetrating through the first rotary member 30. The inner wall between the first end and the second end is a first circular wall 32 that extrudes towards its central axis. The first circular wall 32 partitions the space between the first end and the second end of the first punch 31 into a first space 33 and a second space 34 and there is a first through hole 35 that links the first space 33 and the second space 34 on the center of the first circular wall 32.

### ii. Features of the Second Rotary Member

Referring to FIG. 1 to FIG. 4, the second rotary member 40 of the present invention has a second punch 41, which has a first end and a second end in opposite direction, vertically penetrating through the second rotary member 40. When the second rotary member 40 and the first rotary member 30 are overlapped, the second punch 41 and the first punch 31 will orient towards each other. To be more specific, the second end of the second punch 41 orients towards the second end of the first punch 31. The inner wall of the first is a second circular wall 42 that extrudes towards its central axis and there is a second through hole 43 on the center of the second circular wall 42.

### iii. Features of the Positioning Switch Assembly

Referring to FIG. 1 to FIG. 4, the positioning switch assembly 50 of the present invention comprises:

a press button assembly 51, which is allocated within the first punch 31 of the first rotary member 30, having a pressing portion 52 located at the first end of the first punch 31 with an enlarged outer diameter at one end of the press button assembly 51, a pushing portion 53 close to the second end of the first punch 31 at the other end of the press button assembly 51, a first space 33 to accommodate the pressing portion 52, a first through hole 35 for the middle portion of the press button assembly 51 to penetrate, and a second space 34 to accommodate the pushing portion 53

a first spring 54, which is allocated within the first space 33 of the first punch 31 in the first rotary member 30, with one distal end being against the pressing portion 52 of the press button assembly 51 and another distal end being against the first circular wall 32 in order to provide a first elasticity for the press button assembly 51 to keep the pushing portion 53 away from the second end of the first punch 31 as the press button assembly 51 being in the state of bearing no external force;

a pin 55, which is allocated within the second punch 41 of the second rotary member 40, having a first end and a second end with opposite direction, its second end having a limit portion 56 located at the second of the second punch 41 with an enlarged outer diameter, its first end penetrating the second through hole 43 of the second circular wall 42 and reaching out of the first end of the second punch 41, and at the first end of the pin 55 being mounted a buckling ring 57 which limits the outer portion of the second circular wall 42 in order to limit the pin 55 departing from the second end of the second punch 41; and

a second spring 58, which is allocated within the second punch 41 of the second rotary member 40, with one distal end being against the limit portion 56 of the pin 55 and another distal end being against the second circular wall 42 in order to provide a second elasticity for the pin 55 to keep the limit portion 56 of the pin 55 being partially extended out of the second end of the second punch 41 as the pin 55 bearing no external force.

### iv. Operation of the Present Invention

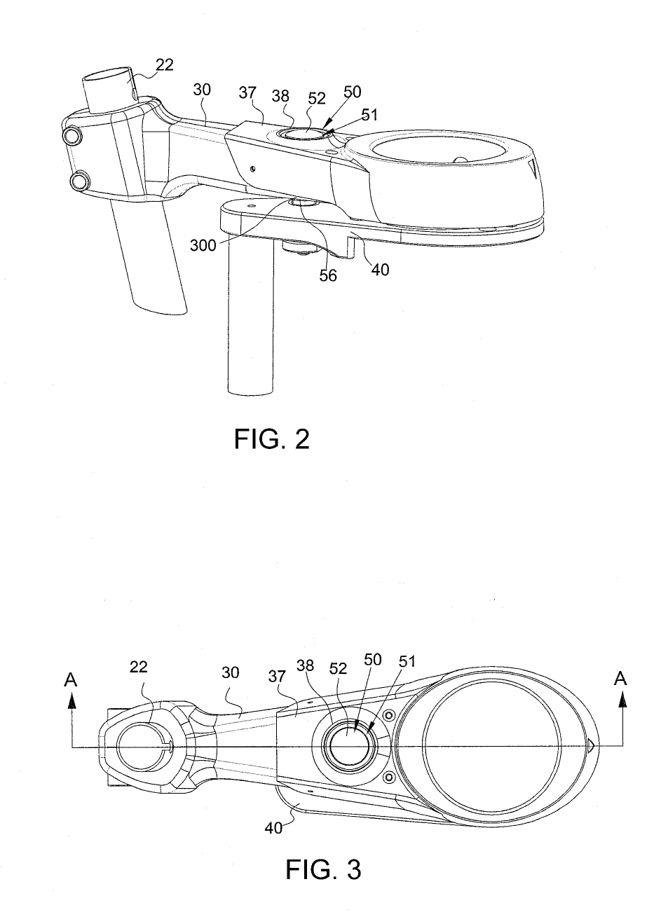

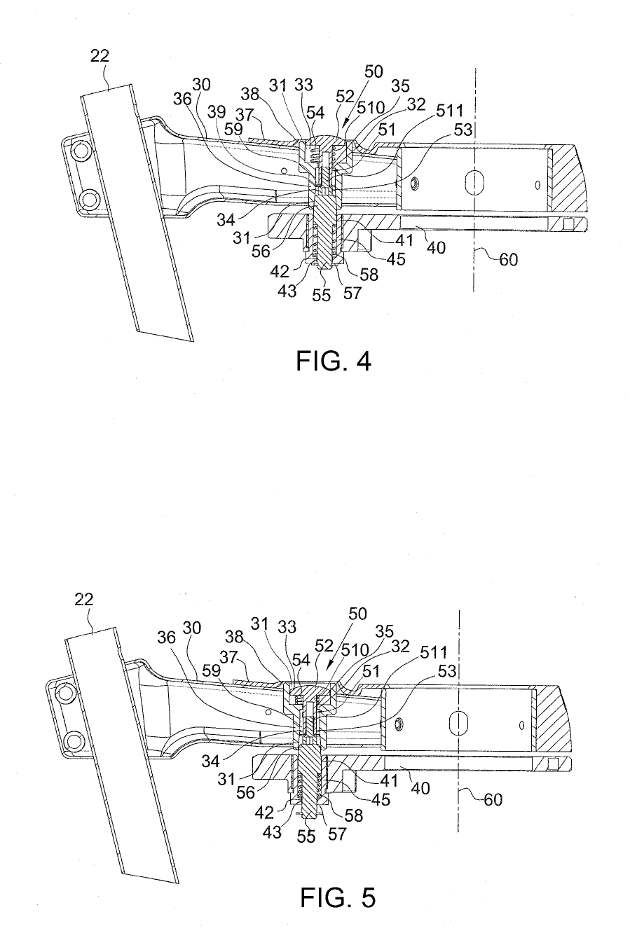

The operation and its principle of the present invention could be easily understood by comparing FIG. 2, FIG. 4 and FIG. 5.

Referring to FIG. 2, when a folding bike is intended to be unfolded for riding, a user can pressure the first rotary member 30 to revolve against the second rotary member 40. When the first rotary member 30 and the second rotary member 40 are close to be overlapped, the limit portion 56 of the pin 55 will first reach the edge 300, with a cone tip or bevel angle, of the first rotary member 30. The limit portion 56 also has a bevel angle, so the first rotary member 40 is able to push the limit portion 56 of the pin 55 and force the second spring 58 to be drowned back into the second punch 41. Therefore, the first rotary member 30 is able to continuously revolve against the second rotary member 40, and at last the first rotary member 30 can be revolved to effectively overlap with the second rotary member 40 shown as FIG. 4. In the mean time, the first punch 31 and the second punch 41 will orient towards each other, and the limit portion 56 will orient towards the first punch 31 as well. Because the limit portion 56 is pushed by the elasticity from the second spring 58, it will be extended out of the second punch 41 again and inserted through the second end of the first punch 31. The positioning switch assembly 50, at this moment, will be in a locked state, and the first rotary member 30 is hence fixed against the second rotary member 40.

Referring to FIG. 5, when the folding bike is intended to be folded for storage or transportation, the user can pressure the pressing portion 52 of the press button assembly 51. When the pressing portion 52 of the press button assembly 51 bears the pressure from the user, the force applied will overcome the elasticity from the first spring 54 and make the pushing portion 53 move towards the second end of the first punch 31 to push the limit portion 56. The limit portion 56 also overcomes the elasticity of the second spring 58 and departs from the first punch 31 for the positioning switch assembly 50 to be in an unlocked state. Therefore, the first rotary member 30 is allowed to be revolved against the second rotary member 40 and the folding bike can be folded for storage or transportation.

### III. Embodiments of the Present Invention or Better Embodiments

In a better embodiment of the present invention shown as FIG. 4, the first punch 31 is formed with a first tube 36 which is thoroughly inserted and fixed in the first rotary member 30 and the second punch 41 is formed with a second tube 45 which is thoroughly inserted and fixed in the second rotary member 40. To construct the first punch 31 and the second punch 41 with the first tube 36 and the second tube 45 relatively not only is convenient for production but also reinforces the structure.

In a better embodiment of the present invention shown as FIG. 1, the press button assembly 51 comprises a first piece 510 and a second piece 511 which are bolted together. The pressing portion 52 is set on the first piece 510 and the pushing portion 53 on the second piece 511. Bolting the first piece 510 and the second piece 511 to form a press button assembly 51 is able to improve the convenience for production and assembly. Not only can it lower the cost, but also can be easier for maintenance.

In a better embodiment of the present invention shown as FIG. 1 and FIG. 4, the outer diameter of the pushing portion 53 is enlarged relative to the second piece 511 and is larger than the inner diameter of the first through hole 35. A washer 59 is placed upon the second piece 511 and is stuck against the pushing portion 53. Furthermore, a flange 39 is set on the wall of the second space 34 to limit the press button assembly 51 moving up when the spring 54 is not pressed. The flange 39 limits the periphery of the washer 59 to make the washer 59 and the press button assembly 51 fix at their position, so the press button assembly 51 is limited to move upwards.

In a better embodiment of the present invention shown as FIG. 1 and FIG. 4, the first rotary member 30 is a tube in order to reduce its weight. On top of the first punch 31 is covered by a plate 37 which is able to enhance the strength of the first rotary member 30. On the plate 37 is a third punch 38 relative to the first punch 31, so the pressing portion 52 of the press button assembly 50 can be slotted into the first punch 31 through the third punch 3.

### IV. Applications of the Present Invention

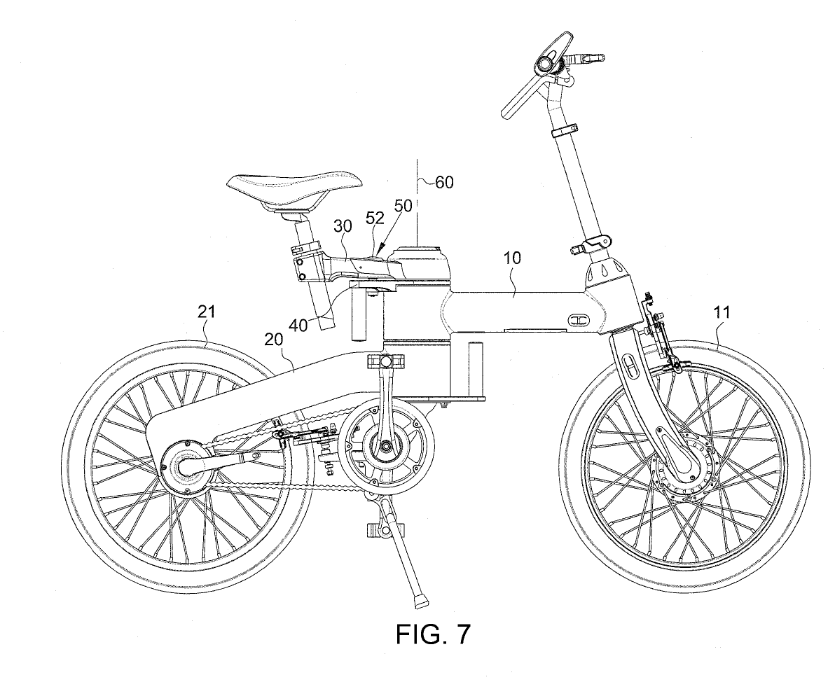

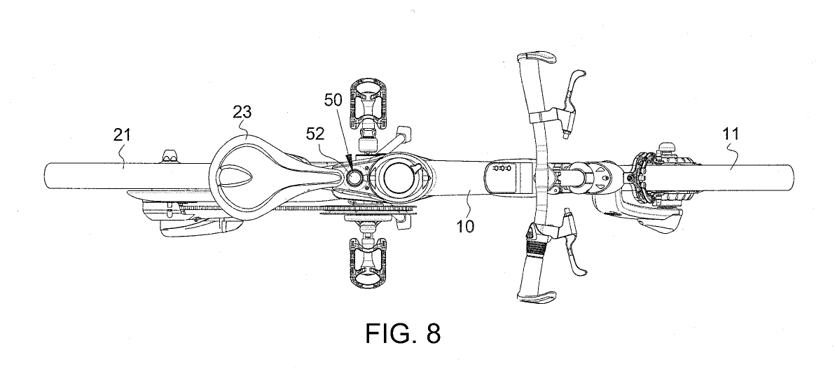

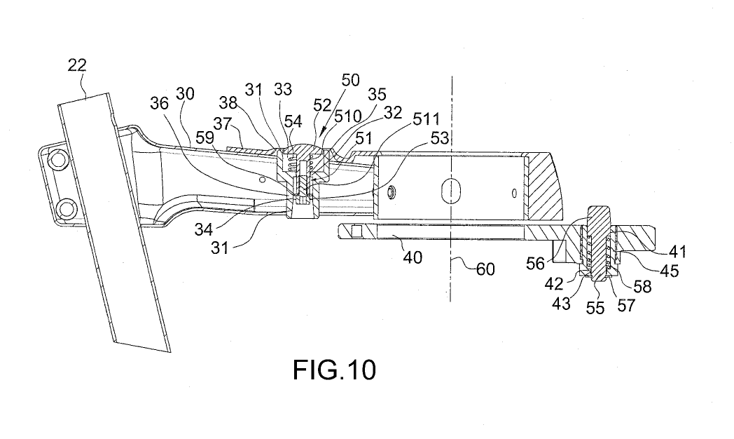

Referring to FIG. 6 to FIG. 10, a bicycle applied the present invention comprises a front frame 10 and a rear frame 20 which are capable of revolving along a rotation axis 60 to be folded. The front frame 10 has a front wheel 11 and the rear frame 20 has a rear wheel 21. A first rotary member 30 and the rear frame 20 are bonded together as a rigid body, and so are a second rotary member 40 and the front frame 10 shown as FIG. 6. When the front frame 10 is extended against the rear frame 20 in a normal riding state, the first rotary member 30 and the second rotary member 40 are in an overlapped state and the positioning switch assembly 50 is in a locked state shown as FIG. 4. When the front frame 10 is folded relative to the rear frame 20 shown as FIG. 9, the first rotary member 30 and the second rotary member 40 departs away from each other and the limit portion 56 of the pin 55 bears the elasticity from the spring 58 to be freely exposed shown as FIG. 10.

Concerning the overall design, the folding bike of the present invention also applies a seat stand 22 held by the first rotary member 30 and there is a seat 23 tightened on top of the seat stand 22 shown as FIG. 6. In other words, the seat 23 is fixed upon the rear frame 20.

### V. Conclusion

From above descriptions of the structure design, the advantages of the present invention can be summarized as below.

1. Easy manipulation: the first rotary member revolves against the second rotary member as the folding bike is unfolded, and the pin is automatically pressed down. When the unfolding action is about to be effectively completed, the pin is automatically slotted into the first punch and to be fixed. When the folding bike is intended to be folded, the user can simply push the pressing portion for the press button assembly to force the pin departing from the first punch. Therefore, both the first rotary member and the second rotary member are able to be revolved against each other for the bike to be folded. The way to manipulate folding and unfolding is very easy.

2. Maximized security: when the folding bike is fully extended, the pin will slot into the first punch for the first rotary member and the second rotary member both to be effectively fixed without arbitrarily deflection. Because the pressing portion is located within the first punch with the support from the elasticity of the first spring, it won't be affected by abnormal external force. Therefore, the security of the bike can be improved.

3. Simplified structure and low cost: the positioning switch assembly mainly comprises a press button assembly, a pin, two springs and a buckling ring, and the press button assembly comprises a first piece, a second piece and a washer. All the parts are simplified with relatively low cost. It is not only convenient for production and assembly, but also easy for maintenance. Therefore, the overall cost can be reduced.

While we have shown and described the embodiment in accordance with the present invention, it should be clear to those skilled in the art that further embodiments may be made without departing from the scope of the present invention.

What is claimed is:

1. A positioning switch mechanism for foldable assembly of bicycles comprising a first rotary member, a second rotary member, a rotation axis and a positioning switch assembly, as the positioning switch assembly being actuated to the unlocked state, the first rotary member being able to be freely revolved against the second rotary member along the rotation axis, and as the positioning switch assembly being actuated to the locked state, the first rotary member being fixed against the second rotary member, wherein:
the first rotary member having a first punch; the first punch having a first end and a second end in opposite direction, and vertically penetrating through the first rotary member; the inner wall between the first end and the second end being provided a first circular wall that extrudes towards its central axis; the first circular wall partitioning the space between the first end and the second end of the first punch into a first space and a second space, the center of the first circular wall being provided a first through hole thereon, and the first through hole linking the first space and the second space;
the second rotary member having a second punch; the second punch having a first end and a second end in opposite direction, and vertically penetrating through the second rotary member; as the second rotary member and the first rotary member being overlapped, the second punch and the first punch orienting towards each other; the inner wall of the first end being provided a second circular wall that extrudes towards its central axis, the center of the second circular wall being provided a second through hole thereon; and
the positioning switch assembly comprising:
a press button assembly, which is allocated within the first punch of the first rotary member, having a pressing portion located at the first end of the first punch with an enlarged outer diameter at one end of the press button assembly and a pushing portion located in a second space at the other end of the press button assembly;
a first spring, which is allocated within the first space of the first punch in the first rotary member, with one distal end being against the pressing portion of the press button assembly and another distal end being against the first circular wall in order to provide a first elasticity for the press button assembly to keep the pushing portion away from the second end of the first punch as the press button assembly being in the state of bearing no external force;
a pin, which is allocated within the second punch of the second rotary member, having a first end and a second end with opposite direction, the second end of the pin having a limit portion being located at the second end of the second punch with an enlarged outer diameter, the first end of the pin penetrating the second through hole of the second circular wall and reaching out of the first end of the second punch, and at the first end of the pin being mounted a buckling ring which limits the outer portion of the second circular wall in order to limit the pin departing from the second end of the second punch; and
a second spring, which is allocated within the second punch of the second rotary member, with one distal end being against the limit portion of the pin and another distal end being against the second circular wall in order to provide a second elasticity for the pin to keep the limit portion being partially extended out of the second end of the second punch as the pin bearing no external force;
as the first rotary member revolving against the second rotary member close to be overlapped, the first rotary member being able to push the limit portion of the pin and forcing the second spring to be drown back into the second punch; as the first rotary member being revolved to effectively overlap with the second rotary member, and the first punch and the second punch orienting towards each other, the limit portion being pushed by the second elasticity from the second spring, being extended out of the second punch again and being inserted through the second end of the first punch, such that the positioning switch assembly being in a locked state and the first rotary member being fixed against the second rotary member; and
as the pressing portion of the press button assembly bearing the pressure from a user, the force applied overcoming the first elasticity from the first spring and making the pushing portion move towards the second end of the first punch to push the limit portion of the pin, the limit portion the pin also overcoming the second elasticity of the second spring and departing from the first punch for the positioning switch assembly to be in an unlocked state, such that the first rotary member being allowed to be revolved against the second rotary member.

2. The positioning switch mechanism for foldable assembly of bicycles as claimed in claim 1, wherein, the first punch is formed with a first tube which is thoroughly inserted and fixed in the first rotary member and the second punch is formed with a second tube which is thoroughly inserted and fixed in the second rotary member.

3. The positioning switch mechanism for foldable assembly of bicycles as claimed in claim 1, wherein, the press button assembly comprises a first piece and a second piece, which are bolted together, with the pressing portion set on the first piece and the pushing portion set on the second piece.

4. The positioning switch mechanism for foldable assembly of bicycles as claimed in claim 3, wherein, the outer diameter of the pushing portion is enlarged, larger than the inner diameter of the first through hole, relative to the second piece and a washer is placed upon the second piece and stuck against the pushing portion.

5. The positioning switch mechanism for foldable assembly of bicycles as claimed in claim 1, wherein, the bicycle comprises a front frame and a rear frame which are capable of revolving along a rotation axis to be folded, the front frame has a front wheel and the rear frame has a rear wheel, the first rotary member and the rear frame are bonded together as a rigid body, and the second rotary member and the front frame are bonded together as a rigid body.

6. The positioning switch mechanism for foldable assembly of bicycles as claimed in claim 1, wherein, a seat stand is held by the first rotary member and there is a seat tightened on top of the seat stand.

7. The positioning switch mechanism for foldable assembly of bicycles as claimed in claim 1, wherein, the first rotary member is a tube and on top of the first punch is covered by a plate which has a third punch relative to the first punch.

8. The positioning switch mechanism for foldable assembly of bicycles as claimed in claim 1, wherein, a flange is set on the wall of the second space to limit the press button assembly moving up as the first spring is not pressed.
